(19) United States
(12) Patent Application Publication
(10) Pub. No.: US 2012/0291625 A1
(43) Pub. Date: Nov. 22, 2012

(54) Nutating swash plate ball bearing assembly

(75) Inventor: Alex Habibvand, Orange, CA (US)

(73) Assignee: ROLLER BEARING COMPANY OF AMERICA, INC., Oxford, CT (US)

(21) Appl. No.: 13/475,097

(22) Filed: May 18, 2012

Related U.S. Application Data
(60) Provisional application No. 61/487,843, filed on May 19, 2011.
(60) Provisional application No. 61/521,823, filed on Aug. 10, 2011.

(51) Int. Cl. F16D 39/00

(52) U.S. Cl. 92/71

(57) ABSTRACT

A swash plate assembly includes a mounting flange. A center ring is disposed in the mounting flange and is rotatable relative to the mounting flange about a center ring axis of rotation. A swash plate is disposed in the center ring and is rotatable relative to the center ring about a swash plate axis of rotation. The swash plate assembly includes a first plurality of balls disposed between the mounting flange and the center ring and a second plurality of balls disposed between the center ring and the swash plate. The center ring defines an inner raceway adapted to receive the first plurality of balls and the center ring defines an outer raceway adapted to receive the second plurality of balls.

### CROSS REFERENCE TO RELATED APPLICATIONS

This application claims the benefit of U.S. Provisional Patent Application No. 61/487,843 filed on May 19, 2011, the contents of which are incorporated herein by reference in their entirety.

This application claims the benefit of U.S. Provisional Patent Application No. 61/521,823 filed on Aug. 10, 2011, the contents of which are incorporated herein by reference in their entirety.

### FIELD OF THE INVENTION

The present invention relates to a swash plate assembly. More specifically, the present invention relates to a swash plate assembly for use in an axial piston pump, wherein the assembly translates a rotating motion of a drive shaft to a reciprocating motion of a swash plate.

### BACKGROUND OF THE INVENTION

A swash plate assembly translates rotating motion to reciprocating motion. Swash plate assemblies have historically been complex and have required a multitude of components to translate rotating motion to reciprocating motion. For example, known swash plate assemblies require a multitude of components disposed between a mounting flange and a swash plate to transfer rotational motion from a drive shaft to the swash plate. As a result, known swash plate assemblies are difficult to manufacture, assemble, and install.

### SUMMARY OF THE INVENTION

The present invention resides in one aspect in an improved swash plate assembly. The swash plate assembly includes a mounting flange. A center ring is disposed in the mounting flange and is rotatable relative to the mounting flange about a center ring axis of rotation. A swash plate is disposed in the center ring and is rotatable relative to the center ring about a swash plate axis of rotation. The swash plate assembly includes a first plurality of balls disposed between the mounting flange and the center ring and a second plurality of balls disposed between the center ring and the swash plate. The center ring defines an inner raceway adapted to receive the first plurality of balls and the center ring defines an outer raceway adapted to receive the second plurality of balls.

The present invention resides in other aspects in an improved swash plate assembly. The swash plate assembly includes a mounting flange. A center ring is disposed in the mounting flange and is rotatable relative to the mounting flange about a center ring axis of rotation. A swash plate is disposed in the center ring and is rotatable relative to the center ring about a swash plate axis of rotation. The swash plate assembly includes a first plurality of balls disposed between the mounting flange and the center ring and a second plurality of balls disposed between the center ring and the swash plate. The center ring defines an inner raceway adapted to receive the first plurality of balls and the center ring defines an outer raceway adapted to receive the second plurality of balls. The mounting flange defines an outer raceway adapted to receive the first plurality of balls. The swash plate defines an inner raceway adapted to receive the second plurality of balls. A diameter of the outer raceway for the second plurality of balls is greater than the diameter of the inner raceway for the second plurality of balls.

### BRIEF DESCRIPTION OF THE DRAWINGS

FIG. 1 is a cross sectional view of a swash plate assembly in accordance with one embodiment of the present invention.

FIG. 2 is a cross sectional view of a swash plate assembly in accordance with one embodiment of the present invention.

### DETAILED DESCRIPTION OF THE INVENTION

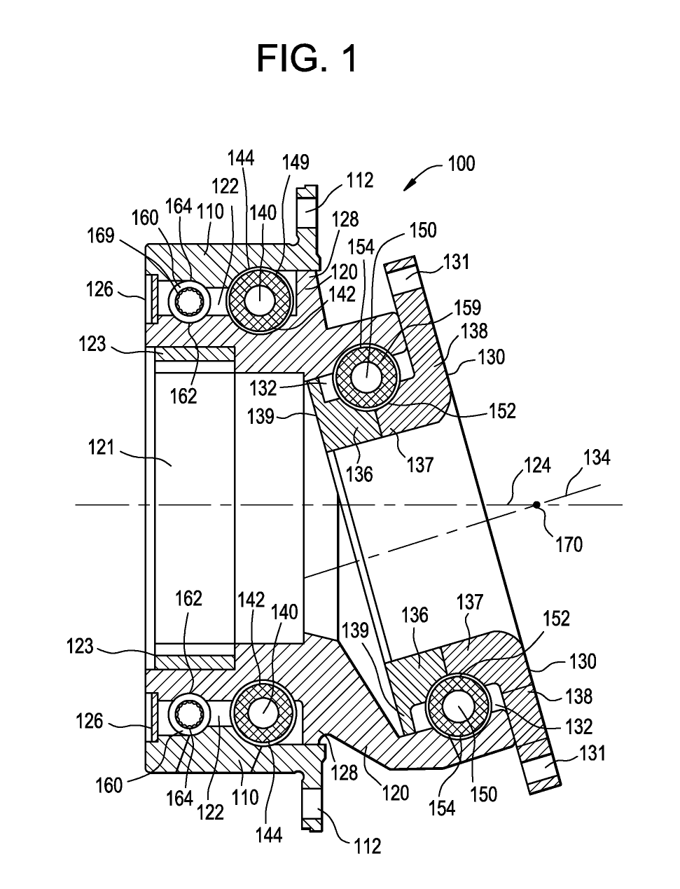

In reference to FIG. 1, a cross sectional view of a swash plate assembly 100 in accordance with one embodiment of the present invention is shown. The swash plate assembly 100 includes a mounting flange 110, a center ring 120, and a swash plate 130. The swash plate assembly 100 can be connected between a drive shaft (not shown in the FIGS.) and one or more links of an axial piston pump (not shown in the FIGS.). The mounting flange 110 defines one or more holes 112 for receiving fasteners or the like for securing the swash plate assembly 100 to a structure, for example, a housing. The swash plate 130 defines one or more holes 131 for receiving fasteners or the like for connecting the swash plate assembly 100 to a structure, for example an axial piston pump. The configuration of the holes 112, 131 are shown for illustration purposes, and is not intended to limited the disclosure as other means of securing the swash plate assembly 100 can also be employed.

The drive shaft (not shown in FIG. 1) is connected to the center ring 120. The drive shaft transfers rotational motion to the center ring 120. A distal end of the drive shaft is received in an opening 121 defined by the center ring 120. The distal end of the drive shaft and the opening 121 defined by the center ring 120 include a complementary pattern of teeth and teeth 123 to limit or prevent rotational slipping of the drive shaft relative to the center ring 120 about a longitudinal axis of the drive shaft, thereby providing efficient transfer of power from the drive shaft to the center ring 120. In the above description, the opening and the distal end of the drive shaft are described as having a complementary pattern of teeth and teeth gaps to inhibit rotation slippage of the drive shaft relative to the center ring 120. However, the disclosure is not limited in this regard and any known method may be used to connect the drive shaft with the center ring 120. For example, in some embodiments the drive shaft is connected to the center ring 120 using a thermal installation. First, the drive shaft is cooled relative to the center ring 120 so that the drive shaft contracts. A distal end of the cooled drive shaft is inserted into the opening 121 defined by the center ring 120. As the temperature of the drive shaft increases the drive shaft expands, creating an interference fit between the shaft and the center ring 120.

The center ring 120 is rotatable relative to the mounting flange 110 about a center ring axis of rotation 124. The swash plate assembly 100 includes a first plurality of balls 140 disposed between the center ring 120 and the mounting flange 110. The center ring 120 defines an inner raceway 142 adapted to receive the first plurality of balls 140 and the mounting flange 110 defines an outer raceway 144 adapted to receive the first plurality of balls 140.

A portion of the swash plate 130 is disposed in the center ring 120. The swash plate 130 is rotatable relative to the center ring 120 about a swash plate axis of rotation 134. The swash plate assembly 100 includes a second plurality of balls 150 disposed between the center ring 120 and the swash plate 130. The center ring 120 defines an outer raceway 154 adapted to receive the second plurality of balls 150. The swash plate 130 defines an inner raceway 152 adapted to receive the second plurality of balls 150. In the embodiment shown in FIG. 1, the outer raceway 154 for the second plurality of balls 150 is adapted to receive both axial and radial loads. The outer raceway 154 faces the swash plate axis of rotation 134. Specifically, a width of the outer raceway 154 is substantially parallel to the swash plate axis of rotation 134. Similarly, a width of the inner raceway 152 is parallel to the swash plate axis of rotation 134. The diameter of the outer raceway 154 for the second plurality of balls 150 is greater than the diameter of the inner raceway 152 for the second plurality of balls 150.

A third plurality of balls 160 is disposed between the center ring 120 and the mounting flange 110. The center ring 120 defines an inner race 162 adapted to receive the third plurality of balls 160. The mounting flange 110 defines an outer raceway 164 adapted to receive the third plurality of balls 160.

The first plurality of balls 140, the second plurality of balls 150, and the third plurality of balls 160 comprise ball bearings. Silicon nitride balls may be used. In some embodiments, steel balls are used. For example, the steel balls may be constructed from M50, 440C, CEVM-52100, or any other known alloy. The balls used in the first plurality of balls 140 and the second plurality of balls 150 are approximately ⅜″ in diameter. The first plurality of balls 140 and the second plurality of balls 150 absorb substantially all of the axial loads received from the axial piston pump (not shown in the FIGS.). The reduction of components in the swash plate assembly 100 compared to know swash plate assemblies makes it possible to use the ⅜″ diameter ball. It should be understood that the diameter of the balls is provided for illustration purposes only and is not intended to limit to present disclosure. The third plurality of balls is provided to preload and the swash plate assembly 100 and receive back lashes forces generated in the loading. It should be understood that although the embodiment shown in FIG. 1 includes a third plurality of balls 160, the present invention is not limited in this regard. For example, a bearing in accordance with the present invention may have more or less than three rows of balls.

The mounting flange 110, the center ring 120, and the swash plate 130 may be constructed from any known suitable material. In the embodiment shown in FIG. 1, the mounting flange 110, the center ring 120, and the swash plate 130 are constructed from nitrogen-rich corrosion resistant alloy XD15NW per AMS-5925. In some embodiments, one or more of the mounting flange 110, the center ring 120, and the swash plate 130 are constructed from Cronidur 30 per AMS-5898.

In the embodiments shown in FIG. 1, the swash plate 130 is manufactured in two pieces 136, 137 to increase the ease of assembly. The two components 136, 137 split perpendicular to the swash plate axis 134. The two pieces 136, 137 are matched and fastened together during final assembly for desired preload and maintaining tightly controlled sealing gaps. It should be understood that the present invention is not limited in this regard and, for example, the swash plate 130 may comprise a single piece or more than two pieces. In addition, the swash plate assembly 130 may be split into different configurations.

The mounting flange 110 and the center ring 120 define a first gap 122. The first gap 122 is adapted to receive a lubricant, such as a grease film, for lubricating the first plurality of balls 140 and the related inner raceway 142 and outer raceway 144, and for lubricating the third plurality of balls 160 and the related inner raceway 162 and outer raceway 164. The first gap 122 is sealed at a first end using a precision-machined integral shield 126. The first gap 122 is sealed at a second end by a portion 128 of center ring 120 that extends radially outward to the mounting flange 110. It should be understood that the above described seals and lubrication is for illustration purposes only and is not intended to limit the present disclosure. For example, other known methods of lubricating and sealing may be used with the swash plate assembly 100 in accordance with the present disclosure.

The center ring 120 and the swash plate 130 define a second gap 132. The second gap 132 is adapted to receive a lubricant, such as a grease film, for lubricating the second plurality of balls 150 and related inner raceway 152 and outer raceway 154. The second gap 132 is sealed at a first end by a portion 138 of the swash plate 130 that extends radially outward. The second gap 132 is sealed at a second end by a portion 139 of the swash plate 130 that extends radially outward to the center ring 120.

In reference to FIG. 1, the center ring axis of rotation 124 and the swash plate axis of rotation 134 intersect at a nutating point 170. The center ring 120 is adapted such that the distance between the nutating point 170 and a face of the mounting plate 110 as measured along the center ring axis of rotation 124 is similar to that of known swash plate assemblies. As a result, the swash plate assembly 100 in accordance with the present invention can readily be exchanged with an existing swash plate assemblies. While the disclosure discloses a specific configuration, the present invention is not limited in this regard, and the distance between the mounting plate 110 and the nutating point 170 can vary.

The plurality of balls 140, 150, 160 are separated using slugs. In the first plurality of balls 140 and the second plurality of balls 150 the slugs 149, 159 are made from carbon fiber reinforced PEEK. In the third plurality of balls 160 PFAtubular slugs 169 are used. In some embodiments, cage separators are used, although the one-piece cage separators have been shown to hinder performance in this application. The slug separators provide freedom for lead-and-lag motions of balls, which is important in this application given the unique loading profile encountered in an axial piston pump.

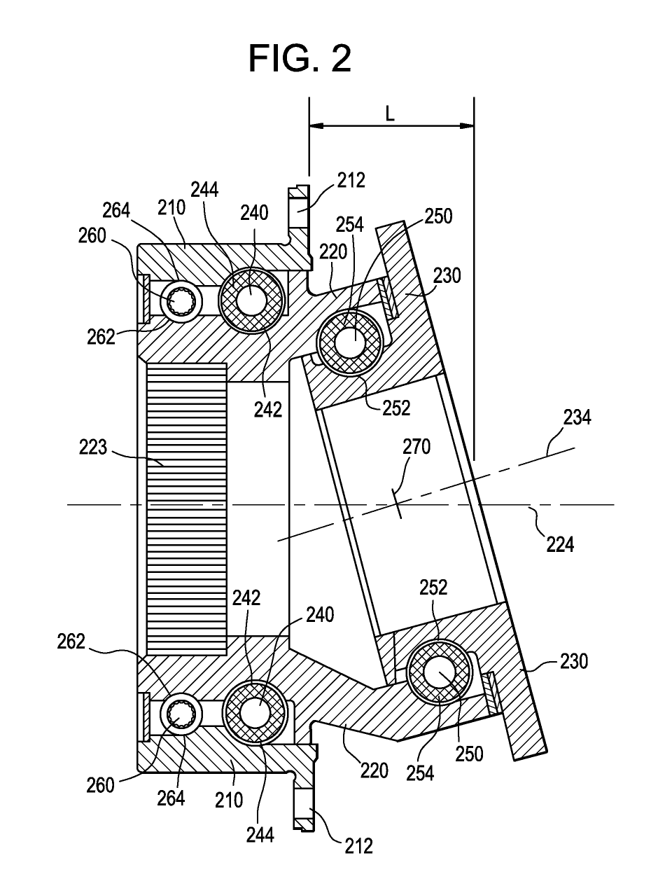

In reference to FIG. 2, a swash plate assembly 200 in accordance with one embodiment of the present invention is disclosed. The swash plate assembly 200 includes a mounting flange 210, a center ring 220, and a swash plate 230. The swash plate assembly 200 can be connected between a drive shaft (not shown in the FIGS.) and one or more links of an axial piston pump (not shown in the FIGS.). The mounting flange 210 defines one or more holes 212 for receiving fasteners or the like for securing the swash plate assembly 200.

The drive shaft (not shown in FIG. 2) is connected to the center ring 220. A distal end of the drive shaft is received in an opening 221 defined by the center ring 220. The distal end of the drive shaft and the opening 221 defined by the center ring 220 include a complementary pattern of teeth and teeth gaps 223 to limit or prevent rotational slipping of the drive shaft relative to the center ring 220 about a longitudinal axis of the drive shaft, thereby providing efficient transfer of power from the drive shaft to the center ring 220. Unlike the embodiment shown in FIG. 1, no additional thermal insulation is provided between the center opening 221 and the drive shaft.

The center ring 220 is rotatable relative to the mounting flange 210 about a center ring axis of rotation 224. The swash plate assembly 200 includes a first plurality of balls 240 disposed between the center ring 220 and the mounting flange 210. The center ring 220 defines an inner raceway 242 adapted to receive the first plurality of balls 240 and the mounting flange 210 defines an outer raceway 244 adapted to receive the first plurality of balls 140.

The swash plate 230 is disposed in the center ring 220. The swash plate 230 is rotatable relative to the center ring 220 about a swash plate axis of rotation 234. The swash plate assembly 200 includes a second plurality of balls 250 disposed between the center ring 220 and the swash plate 230. The center ring 220 defines an outer raceway 254 adapted to receive the second plurality of balls 250. The swash plate 230 defines an inner raceway 252 adapted to receive the second plurality of balls 250. In the embodiment shown in FIG. 1, the outer raceway 254 for the second plurality of balls 250 is adapted to receive both axial and radial loads. The outer raceway 254 faces the swash plate axis of rotation 234. The diameter of the outer raceway 254 for the second plurality of balls is greater than the diameter of the inner raceway 252 for the second plurality of balls.

A third plurality of balls 260 is disposed between the center ring 220 and the mounting flange 210. The center ring 220 defines an inner race 262 adapted to receive the third plurality of balls 260. The mounting flange 210 defines an outer raceway 264 adapted to receive the third plurality of balls 260.

The center ring axis of rotation 224 and the swash plate axis of rotation 234 intersect at a nutating point 270. The center ring 220 of swash assembly 200 is adapted such that the distance between the nutating point 270 and a face of the mounting plate 210 as measured along the center ring axis of rotation 224 is similar to that of known swash plate assemblies. As a result, the swash plate assembly 100 in accordance with the present invention can readily be exchanged with an existing swash plate assembly.

In the embodiment shown in FIG. 2, the center ring axis of rotation 224 and the swash plate axis of rotation 234 intersect at a nutating point 270. The center ring 220 is adapted such that the nutating point 270 is located at or proximate to a center point of the second plurality of balls 250. The distance L between the mounting flange 210 and the swash plate 230 is the same as in known swash plate assemblies such that the disclosed embodiments can be installed into an existing axial piston pump.

Although the present invention has been disclosed and described with reference to certain embodiments thereof, it should be noted that other variations and modifications may be made, and it is intended that the following claims cover the variations and modifications within the true scope of the invention.

What is claimed is:

1. A swash plate assembly comprising:
a mounting flange;
a center ring disposed in the mounting flange, the center ring rotatable relative to the mounting flange about a center ring axis of rotation;
a swash plate disposed in the center ring, the swash plate rotatable relative to the center ring about a swash plate axis of rotation;
a first plurality of balls disposed between the mounting flange and the center ring,
a second plurality of balls disposed between the centering ring and the swash plate;
an inner raceway defined by the center ring adapted to receive the first plurality of balls, and
an outer raceway defined by the center ring adapted to receive the second plurality of balls.

2. The swash plate assembly of claim 1, wherein the outer raceway for the second plurality of balls faces the swash plate axis of rotation.

3. The swash plate assembly of claim 1, wherein the outer raceway for the second plurality of balls is substantially parallel to the swash plate axis of rotation.

4. The swash plate assembly of claim 1, wherein the outer raceway for the second plurality of balls is adapted to receive axial loads and radial loads.

5. The swash plate assembly of claim 1, wherein the inner raceway for the second plurality of balls is substantially parallel to the swash plate axis of rotation.

6. The swash plate assembly of claim 1, further comprising:
a third plurality of balls;
a inner raceway defined by the center ring adapted to receive the third plurality of balls.

7. The swash plate assembly of claim 1, wherein the center ring axis of rotation and the swash plate axis of rotation intersect proximate to a center point of outer raceway for the second plurality of balls.

8. The swash plate assembly of claim 1, wherein the first plurality of balls and the second plurality of balls comprise ball bearings.

9. The swash plate assembly of claim 8, further comprising one or more slug separators for separating one or more of the ball bearings.

10. The swash plate assembly of claim 9, wherein the balls have a diameter of approximately ⅜ inches.

11. The swash plate assembly of claim 10, wherein the balls comprise silicon nitride.

12. The swash plate assembly of claim 1, wherein the one or more of the mounting flange, center ring, and swash plate comprises XD15NW.

13. The swash plate assembly of claim 1, wherein the diameter of the outer raceway for the second plurality of balls is less than or equal to the diameter of the inner raceway for the first plurality of balls.

14. The swash plate assembly of claim 1, further comprising:
an inner raceway defined by the swash plate adapted to receive the second plurality of balls.

15. The swash plate assembly of claim 14, wherein a diameter of the outer raceway for the second plurality of balls is greater than the diameter of the inner raceway for the second plurality of balls.

16. A swash plate assembly comprising:
a mounting flange,
a center ring disposed in the mounting flange, the center ring rotatable relative to the mounting flange about a center ring axis of rotation,
a swash plate disposed in the center ring, the swash plate rotatable relative to the center ring about a swash plate axis of rotation,
a first plurality of balls disposed between the mounting flange and the center ring,
a second plurality of balls disposed between the centering ring and the swash plate,
an inner raceway defined by the center ring adapted to receive the first plurality of balls,
an outer raceway defined by the mounting flange adapted to receive the first plurality of balls,
an inner raceway defined by the swash plate adapted to receive the second plurality of balls,
an outer raceway defined by the center ring adapted to receive the second plurality of balls,
wherein a diameter of the outer raceway for the second plurality of balls is greater than a diameter of the inner raceway for the second plurality of balls.

17. The swash plate assembly of claim 16, wherein the outer raceway for the second plurality of balls is adapted to receive axial loads and radial loads.

18. The swash plate assembly of claim 17, further comprising:
a third plurality of balls, and
a inner raceway defined by the center ring adapted to receive the third plurality of balls.

19. The swash plate assembly of claim 18, further comprising:
one or more bearing separators.

20. The swash plate assembly of claim 16, wherein the center ring axis of rotation and the swash plate axis of rotation intersect proximate to a center point of the outer raceway for the second plurality of balls.
